(19) United States
(12) Patent Application Publication
(10) Pub. No.: US 2020/0242314 A1
(43) Pub. Date: Jul. 30, 2020

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Yuichi Ogawa, Izunokuni Shizuoka (JP)

(21) Appl. No.: 16/702,595

(22) Filed: Dec. 4, 2019

(30) Foreign Application Priority Data
Jan. 25, 2019 (JP) 2019-011099

(51) Int. Cl. G06K 7/10; G06K 19/077

(52) U.S. Cl. CPC G06K 7/10366; G06K 19/07758

(57) ABSTRACT

There is provided an information processing apparatus according to the embodiment including: a storage unit that stores caution information; a tag information receiving unit that receives tag information including information specifying an article from a radio tag attached to the article and received by an antenna; a determination unit that determines whether the received tag information includes information indicating notification of caution information that cautions handling of the radio tag or the article to which the radio tag is attached; and a notification unit that issues notification of the stored caution information from the storage unit when the determination unit determines that the received tag information includes the caution information indicating that a caution is paid to the handling of the radio tag or the article to which the radio tag is attached.

### CROSS-REFERENCE TO RELATED APPLICATION

This application is based upon and claims the benefit of priority from Japanese Patent Application No. 2019-011099, filed in Jan. 25, 2019, the entire contents of which are incorporated herein by reference.

### FIELD

Embodiments described herein relate generally to an information processing apparatus and an information processing method.

### BACKGROUND

Recently, for example, in a store such as amass retailer, a supermarket, or a convenience store, a method of selling a commodity is used, in which a radio tag such as a radio frequency identifier (RFID) tag that stores tag information related to the commodity is attached to the commodity, and the tag information is read by a point of sales (POS) terminal from the radio tag.

When a commodity to which such a radio tag attached is heated in a microwave oven, the radio tag may ignite, so the radio tag needs to be removed from the commodity when the commodity is sold.

For example, in a medical institution or the like, a radio tag is attached to a medicine, and a name and an expiration date of the medicine are stored and managed in the radio tag.

Since there is a concern that these radio tags adversely affect an apparatus such as a cardiac pacemaker, it is necessary to use the radio tags separately from such an apparatus. However, in a store and a medical institution, removing the radio tag may be forgotten and handling of an article to which the radio tag is attached may be mistaken.

### DESCRIPTION OF THE DRAWINGS

FIG. 1 is a perspective view illustrating an appearance of a self-service POS terminal according to an embodiment.

FIG. 2 is a block diagram illustrating a hardware configuration of the self-service POS terminal according to the embodiment.

FIG. 3 is a diagram illustrating an example of tag information of a radio tag.

FIG. 4 is a diagram illustrating an example of a configuration of a caution information unit.

FIG. 5 is a functional block diagram illustrating a functional configuration of the self-service POS terminal.

FIG. 6 is a flowchart illustrating a flow of a control process of the self-service POS terminal.

### DETAILED DESCRIPTION

An object of an exemplary embodiment is to provide an information processing apparatus and an information processing method that prevent handling of a radio tag attached to an article or the article to which the radio tag is attached from being mistaken.

An information processing apparatus according to the embodiment includes: a storage unit that stores caution information; a tag information receiving unit that receives tag information including information specifying an article from a radio tag attached to the article and received by an antenna; a determination unit that determines whether the received tag information includes information indicating notification of caution information that cautions handling of the radio tag or the article to which the radio tag is attached; and a notification unit that issues notification of the stored caution information from the storage unit when the determination unit determines that the received tag information includes the caution information indicating that a caution is paid to the handling of the radio tag or the article to which the radio tag is attached.

Hereinafter, an information processing apparatus and an information processing method according to embodiments will be described with reference to the drawings. In the embodiment, a self-service POS terminal, which is a self-type data sales processing apparatus, will be described as an example of an information processing apparatus. In the embodiment, a commodity is described as an example of an article. The apparatus and the method are not limited to the embodiments described below.

First, a self-service POS terminal 1 will be described. The self-service POS terminal 1 includes a registration unit that reads tag information from a radio tag attached to a commodity to be purchased, and a settlement unit that performs a settlement operation related to the commodity based on the read tag information. Both the sales registration operation in the registration unit and the settlement operation in the settlement unit are performed by a customer himself or herself. The self-service POS terminal 1 executes a sales registration process based on the sales registration operation performed by the customer. The self-service POS terminal 1 executes a settlement process based on the settlement operation performed by the customer.

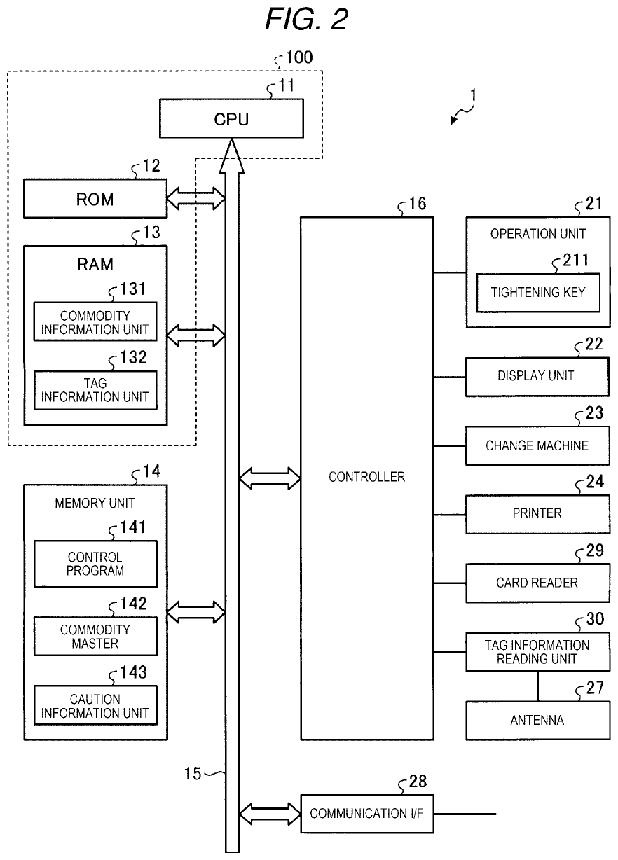

Here, the sales registration process refers to a process of reading commodity information (commodity name, price, or the like) of the commodity from a commodity master 142 (see FIG. 2) based on a commodity code included in the tag information read by the self-service POS terminal 1, displaying the commodity information of the read commodity, and storing the commodity information in a commodity information unit 131 (see FIG. 2). The settlement process refers to a process of displaying a total amount and a tax amount related to the transaction based on the commodity information stored in the commodity information unit 131 in accordance with the sales registration process, calculating and displaying a change based on a deposit received from the customer, and dispensing a receipt printed with commodity information and settlement information (total amount, deposit amount, change amount, or the like), and the like. Information that combines the commodity information and settlement information is referred to as sales information.

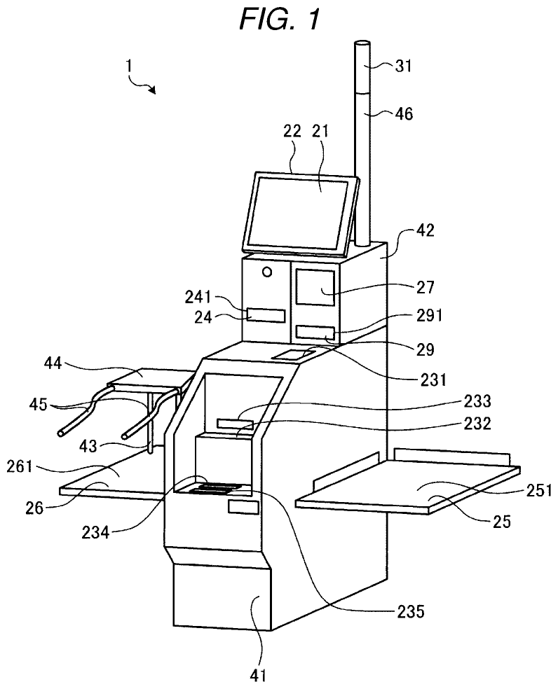

FIG. 1 is a perspective view illustrating an appearance of the self-service POS terminal 1. As illustrated in FIG. 1, the self-service POS terminal 1 includes a first housing 41 and a second housing 42. The first housing 41 accommodates a coin and bill change machine 23 (see FIG. 2) and a control device. The change machine 23 stores coins and bills deposited by customers in denominations. The change machine 23 pays out a change to the customer.

The first housing 41 includes a depositing unit 231 that deposits coins, a dispensing unit 233 that dispenses coin changes, and a tray 232 that receives the dispensed coins. The first housing 41 further includes a depositing unit 234 that deposits bills, and a dispensing unit 235 that dispenses bill changes.

The first housing 41 further includes a placement table 25 and a placement table 26 on left and right of a side. The placement table 25 has a first measuring unit 251. The placement table 26 has a second measuring unit 261.

The placement table 25 is a table for placing a basket in which a commodity to be purchased is placed. The first measuring unit 251 measures a total weight of the basket placed on the placement table 25 and the commodity placed in the basket. The placement table 26 is a table on which a bag, into which a commodity taken out from the placement table 25 is placed, is set. The second measuring unit 261 measures a total weight of the bag set on the placement table 26 and the commodity placed in the bag.

The placement table 26 further includes two support columns 43 extending upward from an upper surface of the placement table 26, a temporary placement table 44 formed at an upper portion of the support columns 43, and two extending rods 45. The extending rod 45 is a rod for setting a shopping bag (not illustrated) in which a commodity of which tag information related to the commodity is read by an antenna 27 (see FIG. 2) is placed. The shopping bag is opened in a state in which a handle of the shopping bag is hooked on the extending rod 45 to facilitate the introduction of the commodity. The temporary placement table 44 is a table for temporarily placing a fragile commodity (tofu or egg) among commodities of which tag information is read by the antenna 27. The commodity placed on the temporary placement table 44 is finally put in the shopping bag.

The second housing 42 is provided at the upper portion of the first housing 41. The second housing 42 accommodates the antenna 27, a printer 24, and a card reader 29 (all refer to FIG. 2). The antenna 27 transmits the received tag information to a tag information reading unit 30. The printer 24 dispenses a receipt by printing the commodity information of the commodity for which the sales registration process is performed by the self-service POS terminal 1 and the settlement information for which the settlement process is performed, on receipt paper. The card reader 29 reads customer specifying information from, for example, an inserted credit card. When making a settlement with a credit card, the self-service POS terminal 1 executes the settlement process based on the customer specifying information read by the card reader 29.

The second housing 42 further includes a discharge unit 241 that discharges the receipt dispensed from the antenna 27 and the printer 24, and an insertion unit 291 that inserts the card into the card reader 29.

The second housing 42 further includes a display unit 22 at a top. The display unit 22 displays the commodity information of the commodity according to the sales registration operation by the customer. The display unit 22 further displays settlement information according to the settlement operation by the customer.

The display unit 22 includes an operation unit 21 formed of a touch panel on a surface. The operation unit 21 serves as a key. The key is operated by operating the operation unit 21 at a position corresponding to various keys displayed on the display unit 22.

The second housing 42 further includes a columnar pole 46 extending upward in a rear side. A light emitting unit 31 is provided at an upper tip of the pole 46. The light emitting unit 31 emits light and notifies an attendant when the customer performs an operation to call the attendant if the self-service POS terminal 1 is in an error state, if the operation of the self-service POS terminal 1 is unknown, or the like.

Next, hardware of the self-service POS terminal 1 will be described. FIG. 2 is a block diagram illustrating a hardware configuration of the self-service POS terminal 1. As illustrated in FIG. 2, the self-service POS terminal 1 includes a Central Processing Unit (CPU) 11, a Read Only Memory (ROM) 12, a Random Access Memory (RAM) 13, a memory unit 14, and the like. The CPU 11 is a control subject. The ROM 12 stores various programs. The RAM 13 loads programs and various data. The memory unit 14 stores various programs. The CPU 11, the ROM 12, the RAM 13, and the memory unit 14 are connected to each other via a bus 15. The CPU 11, the ROM 12, and the RAM 13 constitute a control unit 100. That is, the control unit 100 executes a control process of the self-service POS terminal 1 described later by the CPU 11 operating according to a control program stored in the ROM 12 or the memory unit 14 and loaded in the RAM 13.

The RAM 13 includes a commodity information unit 131 and a tag information unit 132. The commodity information unit 131 stores the commodity information (commodity name, commodity price, or the like) of the commodity for which the self-service POS terminal 1 has performed the sales registration process. The tag information unit 132 stores tag information received by the antenna 27.

The memory unit 14 is configured by a Hard Disc Drive (HDD), a flash memory, or the like, and maintains stored contents even when the power is turned off. The memory unit 14 includes a control program unit 141, a commodity master 142, and a caution information unit (storage unit) 143. The control program unit 141 stores a control program for controlling the self-service POS terminal 1. The commodity master 142 stores the commodity name, a unit price, and the like of the commodity in association with the commodity code that specifies the commodity. The caution information unit 143 stores a plurality of types of caution information related to the handling of the radio tag or the commodity to which the radio tag is attached.

The control unit 100 connects the operation unit 21, the display unit 22, the change machine 23, the printer 24, the card reader 29, and the tag information reading unit 30 via the bus 15 and the controller 16. The operation unit 21 is a keyboard including a tightening key 211 that is operated to end a transaction with the customer. The display unit 22 displays information such as the commodity information and the settlement information for the customer who operates the self-service POS terminal 1. The change machine 23 stores coins inserted by the customer from the depositing unit 231 and bills inserted from the depositing unit 234 by denomination. The change machine 23 pays out coins and bills as change from the dispensing unit 233 and the dispensing unit 235. The printer 24 dispenses a receipt on which the commodity information, the settlement information, or the like is printed. The card reader 29 reads card information of the credit card or the like.

The tag information reading unit 30 connects the antenna 27. The tag information reading unit 30 reads the tag information received by the antenna 27.

The control unit 100 is connected to a communication interface (I/F) 28 via the bus 15. The communication interface 28 is connected to a store server (not illustrated) that is a host device of the self-service POS terminal 1 so that information can be transmitted and received.

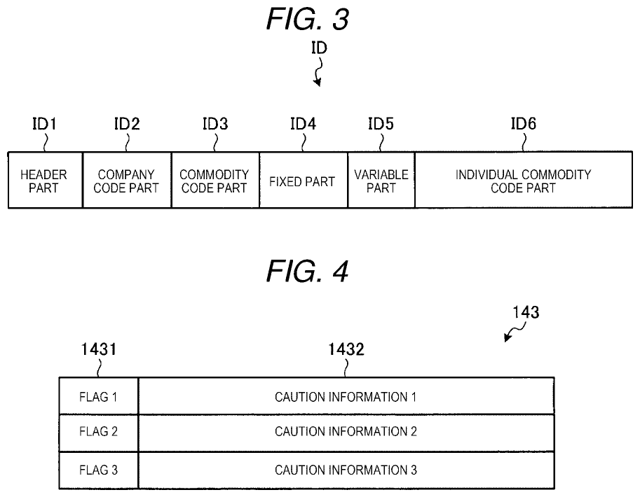

Next, the tag information stored in the radio tag, received by the antenna 27, and read by the tag information reading unit 30 will be described. FIG. 3 is a diagram illustrating an example of the tag information of the radio tag. A tag information ID stores information that specifies the attached commodity. The tag information ID includes each piece of information of a header part ID1, a company code part ID2, a commodity code part ID3, a fixed part ID4, a variable part ID5, an individual commodity code part ID6, and the like. The header part ID1 is header information related to the tag information. The company code part ID2 is a company code that specifies the company that manufactures the commodity to which the radio tag is attached. The commodity code part ID3 is a commodity code (commodity specifying information) that specifies the type of commodity to which the radio tag is attached. The commodity code is information for specifying an article. The fixed part ID4 is non-changeable fixed information related to the tag information. The variable part (information of a specific position) ID5 is variable information that can be changed related to the tag information.

The information of the variable part ID5 is information that can be freely written and changed in the company or the store. Writing or changing information of the variable part ID5 is performed by a reader or a writer (not illustrated). In the embodiment, the variable part ID5 is 2-bit information. When the 2-bit information is “00”, the control unit 100 determines that the variable part ID5 is the flag 0. When the 2-bit information is “01”, the control unit 100 determines that the variable part ID5 is the flag 1. When the 2-bit information is “10”, the control unit 100 determines that the variable part ID5 is the flag 2. When the 2-bit information is “11”, the control unit 100 determines that the variable part ID5 is the flag 3.

The individual commodity code part ID6 is an individual commodity code (individual commodity specifying information) that uniquely specifies a commodity to which the radio tag is attached from other commodities.

Next, the caution information unit 143 will be described. In the embodiment, the caution information unit 143 stores three types of caution information of caution information 1 corresponding to the flag 1, caution information 2 corresponding to the flag 2, and caution information 3 corresponding to the flag 3. The caution information 1 is, for example, caution information (for example, caution information for removing the radio tag before warming the commodity in the microwave oven) related to handling of the radio tag when the commodity is warmed in a microwave oven. When the variable part ID5 of the tag information is “01” (that is, the flag 1), it indicates that the information is caution information 1.

The caution information 2 is, for example, caution information (for example, caution information recommending that a fragile commodity is temporarily placed on the temporary placement table 44) related to handling of easily fragile commodities (for example, eggs and tofu). When the variable part ID5 of the tag information is “10” (that is, the flag 2), it indicates that the information is caution information 2.

The caution information 3 is caution information (for example, caution information for keeping the radio tag away from a cardiac pacemaker) related to handling of the radio tag, for example, when the tag information transmitted by the radio tag affects a medical device. When the variable part ID5 of the tag information is “11” (that is, the flag 3), it indicates the information is the caution information 3.

The customer takes out the commodities one by one from the basket placed on the placement table 25 and passes them in front of the antenna 27. The antenna 27 receives the tag information transmitted from the radio tag attached to the commodity, and the tag information reading unit 30 reads the tag information received by the antenna 27. The customer puts the commodity that has passed in front of the antenna 27 into the shopping bag placed on the placement table 26. The self-service POS terminal 1 determines whether the customer operates correctly depending on whether or not a weight change before and after taking out the commodity by the first measuring unit 251 matches a weight change before and after the introduction of the commodity by the second measuring unit 261. If the weight changes match, the self-service POS terminal 1 executes the sales registration process.

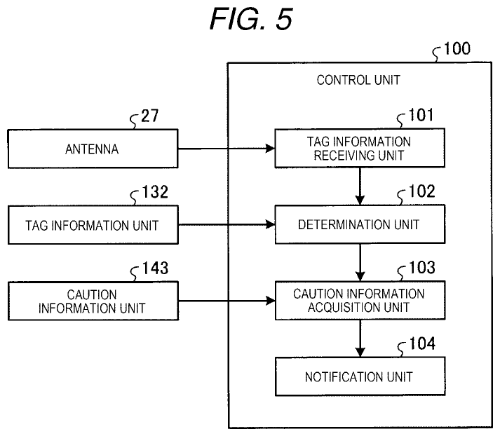

From here, a functional configuration of the self-service POS terminal 1 will be described. FIG. 5 is a functional block diagram illustrating the functional configuration of the self-service POS terminal 1. As illustrated in FIG. 5, the control unit 100 of the self-service POS terminal 1 follows a control program stored in the control program unit 141 and developed in the RAM 13, thereby functioning as the tag information receiving unit 101, the determination unit 102, the caution information acquisition unit 103, and the notification unit 104.

The tag information receiving unit 101 receives the tag information including the commodity code for specifying the commodity from the radio tag attached to the commodity received by the antenna 27. The tag information receiving unit 101 receives the tag information by storing, in the tag information unit 132, the tag information including the commodity code for specifying the commodity from the radio tag attached to the commodity received by the antenna 27.

The determination unit 102 determines whether the received tag information includes information indicating the notification of the caution information that cautions the handling of the radio tag or the commodity to which the radio tag is attached. Specifically, the determination unit 102 determines whether the received tag information includes information indicating the notification of the caution information that cautions the handling of the radio tag, depending on whether any one of the flag 0, the flag 1, the flag 2, and the flag 3 is stored in the variable unit ID 5 in the tag information stored in the tag information unit 132. When the flag 0 is stored in the tag information stored in the tag information unit 132, the determination unit 102 determines that the received tag information does not include the information indicating the notification of the caution information that cautions the handling of the radio tag or the commodity to which the radio tag is attached. When any one of the flag 1, flag 2, and flag 3 is stored in the tag information stored in the tag information unit 132, the determination unit 102 determines that the received tag information includes the information indicating the notification of the caution information that cautions the handling of the radio tag or the commodity to which the radio tag is attached.

When the flag 1 is stored in the tag information stored in the tag information unit 132, the determination unit 102 determines that the received tag information includes the information indicating the notification of caution information 1 that cautions the handling of the radio tag. When the flag 2 is stored in the tag information stored in the tag information unit 132, the determination unit 102 determines that the received tag information includes the information indicating the notification of caution information 2 that cautions the handling of the radio tag. When the flag 3 is stored in the tag information stored in the tag information unit 132, the determination unit 102 determines that the received tag information includes the information indicating the notification of caution information 3 that cautions the handling of the radio tag.

The caution information acquisition unit 103 acquires the caution information included in the tag information. Specifically, when the determination unit 102 determines that the received tag information includes the information indicating the notification of the caution information 1 that cautions the handling of the radio tag, the caution information acquisition unit 103 acquires the caution information from the caution information unit 143. More specifically, when the determination unit 102 determines that the received tag information includes the information indicating the notification of the caution information 1 that cautions the handling of the radio tag, the caution information acquisition unit 103 acquires the caution information 1 from the caution information unit 143. When the determination unit 102 determines that the received tag information includes the information indicating the notification of the caution information 2 that cautions the handling of the radio tag, the caution information acquisition unit 103 acquires the caution information 2 from the caution information unit 143. When the determination unit 102 determines that the received tag information includes the information indicating the notification of the caution information 3 that cautions the handling of the radio tag, the caution information acquisition unit 103 acquires the caution information 3 from the caution information unit 143.

When the determination unit 102 determines that the received tag information does not include the information indicating the notification of the caution information that cautions the handling of the radio tag, the caution information acquisition unit 103 does not acquire the caution information.

When the determination unit 102 determines that the received tag information includes the caution information indicating that a caution is paid to the handling of the radio tag or the commodity to which the radio tag is attached, the notification unit 104 issues notification of the caution information stored in the caution information unit 143. Specifically, when the determination unit 102 determines that the received tag information includes the caution information indicating that the caution is paid to the handling of the radio tag or the commodity to which the radio tag is attached, the notification unit 104 displays, on the display unit 22, the caution information acquired by the caution information acquisition unit 103 based on the determination of the determination unit 102.

More specifically, when the caution information acquisition unit 103 acquires the caution information 1, the notification unit 104 displays the caution information 1 on the display unit 22. When the caution information acquisition unit 103 acquires the caution information 2, the notification unit 104 displays the caution information 2 on the display unit 22. When the caution information acquisition unit 103 acquires the caution information 3, the notification unit 104 displays the caution information 3 on the display unit 22.

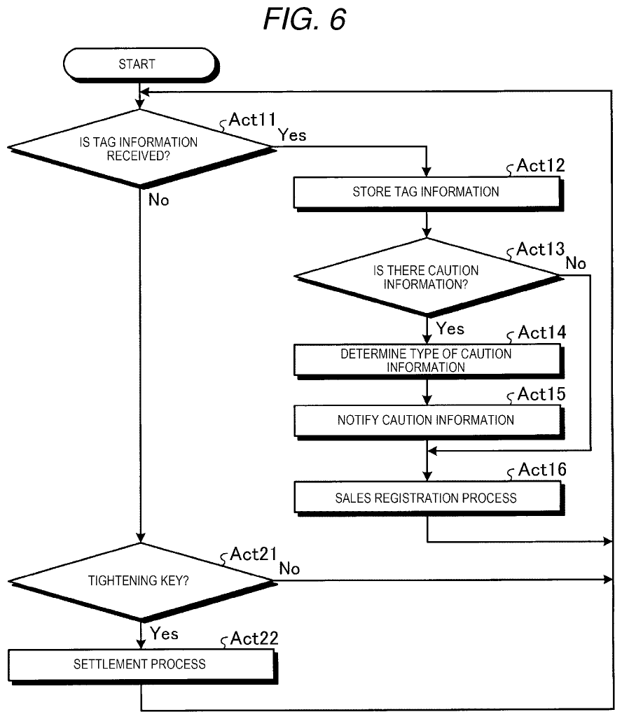

From here, control of the self-service POS terminal 1 will be described. FIG. 6 is a flowchart illustrating a flow of a control process of the self-service POS terminal 1. As illustrated in FIG. 6, the control unit 100 of the self-service POS terminal 1 determines whether the antenna 27 has received the tag information (Act11). When it is determined that the antenna 27 has received the tag information (Yes in Act11), the tag information receiving unit 101 stores (receives the tag information) the tag information in the tag information unit 132 (Act12).

Next, the determination unit 102 determines whether the received tag information includes the information indicating the notification of the caution information that cautions the handling of the radio tag or the commodity to which the radio tag is attached (Act13). When it is determined that the received tag information includes the information indicating the notification of the caution information that cautions the handling of the radio tag or the commodity to which the radio tag is attached (Yes in Act13), the determination unit 102 determines the type (in the embodiment, caution information 1, caution information 2, or caution information 3) of the caution information included in the tag information (Act14). The notification unit 104 acquires the type of the caution information determined by the determination unit 102, from the caution information unit 143 and displays (notifies) the information on the display unit 22 (Act15).

Next, the control unit 100 executes the sales registration process of the commodity based on the commodity code included in the received tag information (Act16). The control unit 100 returns to Act11. When it is determined that the received tag information does not include the information indicating the notification of the caution information that cautions the handling of the radio tag or the commodity to which the radio tag is attached (No in Act13), the control unit 100 performs a process of Act16 without displaying, on the display unit 22, the handling of the commodity or the radio tag attached to the commodity.

In Act11, when it is determined that the antenna 27 has not received the tag information (No in Act11), the control unit 100 determines whether the tightening key 211 has been operated (Act21). When it is determined that the tightening key 211 has been operated (Yes in Act21), the control unit 100 performs the sales registration process in Act16 and executes the settlement process for the commodity stored in the commodity information unit 131 (Act22). The control unit 100 returns to Act11. When it is determined that there is no operation in the tightening key 211 (No in Act21), the control unit 100 returns to Act11.

According to such an embodiment, the determination unit 102 determines that the tag information received by the tag information receiving unit 101 includes information indicating the notification of the caution information that cautions the handling of the radio tag or the commodity to which the radio tag is attached. When the determination unit 102 determines that the caution information is included, the notification unit 104 issues notification of the caution information stored in the caution information unit 143. Therefore, it is possible to prevent mistaken handling of the radio tag attached to the commodity or the commodity to which the radio tag is attached.

According to the embodiment, the determination unit 102 determines whether the tag information includes the caution information indicating that the caution is paid to the handling of the radio tag or the commodity to which the radio tag is attached, based on information of a specific position of the read tag information. Therefore, when caution is paid to the handling of the radio tag or the commodity to which the radio tag is attached, the determination unit 102 determines whether the received tag information includes the information indicating the notification of the caution information that cautions the handling of the radio tag or the commodity to which the radio tag is attached only by attaching the radio tag having the variable part ID5 of “01”, “10”, or “11” to the commodity. Therefore, when the number of radio tags or the commodities to which the radio tags are attached to caution the handling is increased, it is not necessary to change the data of the commodity master 142 of the self-service POS terminal 1.

According to the embodiment, the caution information unit 143 stores a plurality of types of caution information, and the notification unit 104 issues notification of the types of caution information determined by the determination unit 102. Therefore, in various situations, by attaching a radio tag corresponding to the situation to a commodity or an article, it is possible to notify the caution information corresponding to the situation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiment, the self-service POS terminal 1 is described as an example of the information processing apparatus. In addition, the commodity is described as an example of the article. However, embodiments are not limited to the examples. For example, the information processing apparatus includes a POS terminal where a salesclerk performs the sales registration operation and the settlement operation of the commodity, or a commodity registration apparatus, and a settlement apparatus. The information processing apparatus may be a commodity registration apparatus in a semi-self-service type POS terminal in which the salesclerk performs the commodity sales registration operation in the commodity registration apparatus and the customer performs the settlement operation in the settlement apparatus. In addition, a medicine inspection apparatus that inspects a medicine may be an information processing apparatus, and a medicine may be an article. In this case, a radio tag is attached to the medicine, the tag information is read from the radio tag by the medicine inspection apparatus, and the suitability of the medicine to be administered to a patient (whether the medicine is correct or the expiration date has not expired) is inspected. In this case, for example, the radio tag may be notified of a caution article 3 indicating that the radio tag is not brought close to the cardiac pacemaker so that the radio tag does not adversely affect the cardiac pacemaker.

In the embodiment, the tag information is read by removing the commodity from the basket and passing in front of the antenna 27. However, embodiments are not limited to the examples, and a radio tag attached to a commodity placed in the basket may be simultaneously read by the antenna by placing the basket on a table in which the antenna 27 is installed below. In this case, the customer recognizes that there is a commodity on which a caution article is displayed in the basket, searches for the commodity from the basket, and handles the commodity according to the caution information.

A program executed in the self-service POS terminal 1 of the embodiment is provided by being recorded on a computer-readable recording medium in a file in an installable or executable format, such as a CD-ROM, a flexible disk (FD), a CD-R, or a Digital Versatile Disk (DVD).

The program executed by the self-service POS terminal 1 of the embodiment may be provided by being stored on a computer connected to a network such as the Internet and downloaded via the network. The program executed by the self-service POS terminal 1 of the embodiment may be provided or distributed via the network such as the Internet.

The program executed by the self-service POS terminal 1 of the embodiment may be provided by being incorporated in advance in a ROM or the like.

What is claimed is:

1. An information processing apparatus, comprising:
a storage component that stores caution information;
a tag information receiver that receives tag information including information specifying an article from a radio tag attached to the article and received by an antenna;
a determination component that determines whether the received tag information includes information indicating notification of caution information that cautions handling of the radio tag or the article to which the radio tag is attached; and
a notification component that issues a notification of the caution information from the storage component when the determination component determines that the received tag information includes the caution information indicating that a caution is paid to handling of the radio tag or the article to which the radio tag is attached.

2. The apparatus according to claim 1,
wherein the determination component determines whether the tag information includes the caution information indicating that caution is paid to the handling of the radio tag or the article to which the radio tag is attached, based on information included in a specific position of the tag information.

3. The apparatus according to claim 2,
wherein the storage component stores a plurality of types of caution information,
the determination component determines a type of caution information included in the tag information, and
the notification component reads the determined type of caution information from the storage component and issues the notification of the caution information.

4. The apparatus according to claim 3,
wherein the determination component determines the type of the caution information based on information of a multiple-digit specific bit position included in the specific position.

5. The apparatus according to claim 1,
wherein the article is a commodity,
the information processing apparatus is a self-service type data sales processing apparatus in which a customer performs a sales registration operation and a settlement operation of the commodity, and
the notification component notifies the customer of the caution information related to the handling of the commodity for which the sales registration operation is performed, the radio tag attached to the commodity, or the article to which the radio tag is attached.

6. The apparatus according to claim 1,
wherein the tag information comprises a commodity code.

7. The apparatus according to claim 1,
wherein the caution information comprises at least one of
caution information for removing the radio tag before warming the commodity in an oven,
caution information relating to handling of easily breakable and fragile commodities, and
caution information for keeping the radio tag away from a medical device.

8. The apparatus according to claim 1,
wherein the notification component issues at least one of an audible notification and a visual notification.

9. An information processing method executed by a computer as an information processing apparatus comprising a storage component that stores caution information, the method comprising:
receiving tag information including information specifying an article from a radio tag attached to the article and received by an antenna;
determining whether the received tag information includes information indicating notification of caution information that cautions handling of the radio tag or the article to which the radio tag is attached; and
issuing notification of the stored caution information from the storage component when determining that the received tag information includes the caution information indicating that a caution is paid to handling of the radio tag or the article to which the radio tag is attached.

10. The method according to claim 9, further comprising:
determining whether the tag information includes the caution information indicating that caution is paid to the handling of the radio tag or the article to which the radio tag is attached, based on information included in a specific position of the tag information.

11. The method according to claim 10, further comprising:
determining a type of caution information included in the tag information,
reading the determined type of caution information from the storage component and issuing the notification of the caution information, and
determining the type of the caution information based on information of a multiple-digit specific bit position included in the specific position.

12. The method according to claim 9,
wherein the article is a commodity, further comprising:
sales registering the commodity, and
notifying the customer of the caution information related to the handling of the commodity for which sales registering is performed, the radio tag attached to the commodity, or the article to which the radio tag is attached.

13. A POS terminal, comprising:
a settlement processing component;
a storage component that stores caution information;
a tag information receiver that receives tag information including information specifying an article from a radio tag attached to the article and received by an antenna;
a determination component that determines whether the received tag information includes information indicating notification of caution information that cautions handling of the radio tag or the article to which the radio tag is attached; and
a notification component that issues a notification of the caution information from the storage component when the determination component determines that the received tag information includes the caution information indicating that a caution is paid to handling of the radio tag or the article to which the radio tag is attached.

14. The POS terminal according to claim 13,
wherein the determination component determines whether the tag information includes the caution information indicating that caution is paid to the handling of the radio tag or the article to which the radio tag is attached, based on information included in a specific position of the tag information.

15. The POS terminal according to claim 14,
wherein the storage component stores a plurality of types of caution information,
the determination component determines a type of caution information included in the tag information, and
the notification component reads the determined type of caution information from the storage component and issues the notification of the caution information.

16. The POS terminal according to claim 15,
wherein the determination component determines the type of the caution information based on information of a multiple-digit specific bit position included in the specific position.

17. The POS terminal according to claim 13,
wherein the article is a commodity,
the information processing apparatus is a self-service type data sales processing apparatus in which a customer performs a sales registration operation and a settlement operation of the commodity, and
the notification component notifies the customer of the caution information related to the handling of the commodity for which the sales registration operation is performed, the radio tag attached to the commodity, or the article to which the radio tag is attached.

18. The POS terminal according to claim 13,
wherein the tag information comprises a commodity code.

19. The POS terminal according to claim 13,
wherein the caution information comprises at least one of
caution information for removing the radio tag before warming the commodity in an oven,
caution information relating to handling of easily breakable and fragile commodities, and
caution information for keeping the radio tag away from a medical device.

20. The POS terminal according to claim 13,
wherein the notification component issues at least one of an audible notification and a visual notification.
